(19) United States
(12) Patent Application Publication
(10) Pub. No.: US 2025/0336168 A1
(43) Pub. Date: Oct. 30, 2025

(54) MULTIMEDIA SYSTEM AND IMAGE DISPLAY METHOD

(71) Applicant: Optoma Corporation, New Taipei City (TW)

(72) Inventor: Wen-Tai Wang, New Taipei City (TW)

(73) Assignee: Optoma Corporation, New Taipei City (TW)

(21) Appl. No.: 19/063,310

(22) Filed: Feb. 26, 2025

(30) Foreign Application Priority Data
Apr. 26, 2024 (TW) 113115632

(51) Int. Cl. G06T 19/20; G06F 3/01; G06F 3/04815; G06F 3/0484; G06F 3/0489; G06F 3/16

(52) U.S. Cl. CPC G06T 19/20; G06F 3/011; G06F 3/017; G06F 3/04815; G06F 3/0484; G06F 3/0489; G06F 3/167; G06T 2200/24; G06T 2219/2004

(57) ABSTRACT

A multimedia system and an image display method are provided. The multimedia system includes a processing unit, an input unit, and a display unit. The input unit provides input data. The processing unit communicatively connects to the input unit, and the processing unit generates an operation instruction according to the input data, and generates a composite image. The display unit communicatively connects to the processing unit and displays a selection interface and the composite image. The composite image includes a three-dimensional avatar image and a display content. The processing unit determines a position of the three-dimensional avatar image relative to the display content according to a selection result of the selection interface, and the processing unit adjusts the three-dimensional avatar image according to the operation instruction.

### CROSS-REFERENCE TO RELATED APPLICATION

This application claims the priority benefit of Taiwan application serial no. 113115632, filed on Apr. 26, 2024. The entirety of the above-mentioned patent application is hereby incorporated by reference herein and made a part of this specification.

### BACKGROUND

### Technical Field

The disclosure relates to a multimedia system, and particularly relates to a multimedia system that can display a three-dimensional avatar image and an image display method applied to the multimedia system.

### Description of Related Art

Although there are currently devices capable of generating and displaying applications related to three-dimensional avatar images, there is no device that can generate real-time actions on the three-dimensional avatar images and provide a good user experience in controlling the three-dimensional avatar images. In other words, the current three-dimensional avatar images can only display monotonous display contents and display effects.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a multimedia system and an image display method that can combine a three-dimensional avatar image with a display content, and the user can control the at least one action of the three-dimensional avatar image.

Other purposes and advantages of the disclosure may be further understood from the technical features disclosed in the disclosure. In order to achieve one, part, or all of the above purposes or other purposes, a multimedia system according to an embodiment of the disclosure includes a processing unit, an input unit, and a display unit. The input unit provides input data. The processing unit communicatively connects to the input unit, and the processing unit generates an operation instruction according to the input data, and generates a composite image. The display unit communicatively connects to the processing unit and displays the composite image. The composite image includes a three-dimensional avatar image and a display content. The processing unit determines a position of the three-dimensional avatar image relative to the display content, and the processing unit adjusts the three-dimensional avatar image according to the operation instruction.

In an embodiment of the disclosure, the display unit displays a selection interface so as to generate a selection result from the selection interface. According to the selection result, the processing unit adjusts the position of the three-dimensional avatar image being outside the display content or the position of the three-dimensional avatar image being within the display content or the position of the three-dimensional avatar image within the display content in three-dimensional coordinate.

In an embodiment of the disclosure, the processing unit reads a corresponding action script according to the input data provided by the input unit, and generates the operation instruction according to the corresponding action script.

In an embodiment of the disclosure, the input unit includes an image capturer. The processing unit is used to capture a real-life image through the image capturer, and the display content includes the real-life image.

In an embodiment of the disclosure, the input unit includes an image capturer. The processing unit is used to detect a posture change of a user through the image capturer, and generate the operation instruction according to the posture change.

In an embodiment of the disclosure, the input unit includes an image capturer. The processing unit is used to detect a gesture change of a user through the image capturer, and generate the operation instruction according to the gesture change.

In an embodiment of the disclosure, the input unit includes a mouse or a keyboard. The processing unit is used to generate the operation instructions according to an operation result of the mouse or the keyboard.

In an embodiment of the disclosure, the input unit includes a microphone. The processing unit is used to obtain a sound signal from the microphone, and generate the operation instruction according to the sound signal.

In an embodiment of the disclosure, the processing unit further communicatively connects to a terminal device, the processing unit outputs the composite image to the terminal device, and a display device of the terminal device displays the composite image.

Other purposes and advantages of the disclosure may be further understood from the technical features disclosed in the disclosure. In order to achieve one, part, or all of the above purposes or other purposes, an image display method according to an embodiment of the disclosure includes steps as follows: generating, by a processing unit, a composite image; providing, by an input unit, input data; generating, by the processing unit, an operation instruction according to the input data; displaying, by a display unit, the composite image, in which the composite image includes a three-dimensional avatar image and a display content; determining, by the processing unit, a position of the three-dimensional avatar image relative to the display content; and adjusting, by the processing unit, the three-dimensional avatar image according to the operation instruction.

In an embodiment of the disclosure, the method further includes: displaying, by the display unit, a selection interface so as to generate a selection result; and adjusting, according to the selection result, the position of the three-dimensional avatar image being outside the display content or the position of the three-dimensional avatar image being within the display content or the position of the three-dimensional avatar image within the display content in three-dimensional coordinate by the processing unit.

In an embodiment of the disclosure, the image display method further includes steps as follows: reading a corresponding action script according to the input data provided by the input unit; and generating the operation instruction according to the corresponding action script.

In an embodiment of the disclosure, the image display method further includes steps as follows: capturing a real-life image through an image capturer, and wherein the display content includes the real-life image.

In an embodiment of the disclosure, the step of generating the operation instruction includes: detecting a posture change of a user through an image capturer, and generating the operation instruction according to the posture change.

In an embodiment of the disclosure, the step of generating the operation instruction includes: detecting a gesture change of a user through an image capturer, and generating the operation instruction according to the gesture change.

In an embodiment of the disclosure, the step of generating the operation instruction includes: generating the operation instruction according to an operation result of a mouse or a keyboard.

In an embodiment of the disclosure, the step of generating the operation instruction includes: obtaining a sound signal according to a microphone, and generating the operation instruction according to the sound signal.

In an embodiment of the disclosure, the image display method further includes steps as follows: outputting the composite image to a terminal device, so that the terminal device displays the composite image.

Based on the above, the multimedia system and the image display method of the disclosure can combine the three-dimensional avatar image with the display content to generate the composite image, and can adjust the three-dimensional avatar image according to the operation instruction generated by the input unit.

In order to make the above-mentioned features and advantages of the disclosure more comprehensible, embodiments are given below and described in detail with reference to the accompanying drawings.

Other objectives, features and advantages of the disclosure will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a multimedia system according to an embodiment of the disclosure.

FIG. 2 is a flow chart of an image display method according to an embodiment of the disclosure.

FIG. 3 is a schematic diagram of generating a composite image according to an embodiment of the disclosure.

FIG. 4A is a schematic diagram of the composite image according to an embodiment of the disclosure.

FIG. 4B is a schematic diagram of the composite image according to an embodiment of the disclosure.

FIG. 4C is a schematic diagram of the composite image according to an embodiment of the disclosure.

FIG. 5 is a flow chart of adjusting the three-dimensional avatar image according to an embodiment of the disclosure.

FIG. 6 is a flow chart of adjusting the three-dimensional avatar image according to an embodiment of the disclosure.

FIG. 7 is a flow chart of adjusting the three-dimensional avatar image according to an embodiment of the disclosure.

FIG. 8 is a flow chart of generating the composite image according to an embodiment of the disclosure.

FIG. 9 is a schematic diagram of a mixed real-life image with the three-dimensional avatar image according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

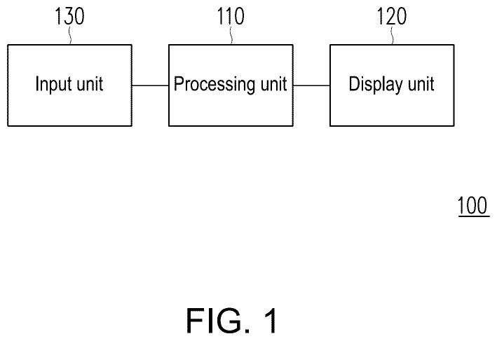

FIG. 1 is a schematic diagram of a multimedia system according to an embodiment of the disclosure. Referring to FIG. 1, a multimedia system 100 includes a processing unit 110, a display unit 120, and an input unit 130. The processing unit 110 communicatively connects to the display unit 120 and the input unit 130 respectively. Communicative connection is defined as the connection manner for transmitting signals between the two units. In this embodiment, the multimedia system 100 is, for example, an interactive flat panel (IFP) with a touch function, an electronic whiteboard with a networking function, a personal computer (PC), a tablet computer, a smart phone, or a similar electronic device. In this embodiment, the user can, for example, use a mobile phone with a depth-of-field capture function, a camera or video camera with a depth-of-field capture function, or a 360-degree camera to scan the appearance of the user to generate an image of the user, to create a three-dimensional avatar image of the user and store in a storage device of the multimedia system 100, in which the user image is different from the three-dimensional avatar image of the user. The processing unit 110 may execute a production program stored in the storage device to produce the user image into the three-dimensional avatar image of the user.

In this embodiment, the processing unit 110 of the multimedia system 100 can perform related image processing and related data operations for implementing the disclosure, and can display a composite image including a display content and a three-dimensional avatar image through the display unit 120. The processing unit 110 of the multimedia system 100 can control at least one of the display content and the three-dimensional avatar image in the composite image according to an operation instruction generated by the input unit 130. In this embodiment, the display content may be, for example, a video (such as a streaming image on the YouTube platform), a presentation (such as a PPT file), a document (such as a WORD file or PDF file) or an image, and the disclosure is not limited thereto.

In this embodiment, the processing unit 110 may include at least one processor, such as a central processing unit (CPU) with image data processing function or data computing function, or other programmable general-purpose or special-purpose microprocessor, an image processing unit (IPU), a graphics processing unit (GPU), a digital signal processor (DSP), an application specific integrated circuit (ASIC), a programmable logic device (PLD), other similar computing circuits, or a combination of the circuits. The multimedia system 100 may further include a storage device. The storage device includes, for example, any type of hard disk drive (HDD), a non-volatile memory storage device (such as SSD or flash memory), a dynamic random access memory (DRAM), or a static random access memory (SRAM). The storage device is electrically connected (communicatively connected) to the processing unit 110. The processing unit 110 is used to access at least one module stored in the storage device, for example, the action script module 111, the action triggering module 112, the control module 113, the content mixing module 114, and a recognition program. Also, the each of above-mentioned modules is, for example, at least one software, program, and the functions of each module will be described in subsequent content.

In this embodiment, the display unit 120 may be a display device, a projector, or a wearable display such as smart glasses of AR (augmented reality)/MR (mixed reality), or other display devices.

In this embodiment, the input unit 130 may include at least one of an image capturer (camera etc.), a mouse, a keyboard, and a microphone. In this embodiment, the multimedia system 100 may further include a communication interface for communicatively connecting to other terminal devices. The communication interface is communicatively connected to the processing unit 110. The communication interface is, for example, a communication circuit or chip complying with the Ethernet specification or the Wireless LAN specification, or a high definition multimedia interface (HDMI), or a universal serial bus (USB).

In an embodiment, the processing unit 110 may further communicatively connect to an external terminal device through the communication interface, and the processing unit 110 may further output a composite image to the terminal device, so that a display device of the terminal device displays the composite image. The terminal device may be, for example, a smart phone, a tablet computer, a desktop computer, or a laptop computer, and the disclosure is not limited thereto. The processing unit 110 may, for example, provide the composite image to an interactive display device (such as an IFP) communicatively connected to the multimedia system 100 through network communication, or to at least one other terminal device or projector. In this regard, the display unit 120 of the multimedia system 100 of the user and other terminal devices or projectors may all display the same composite image.

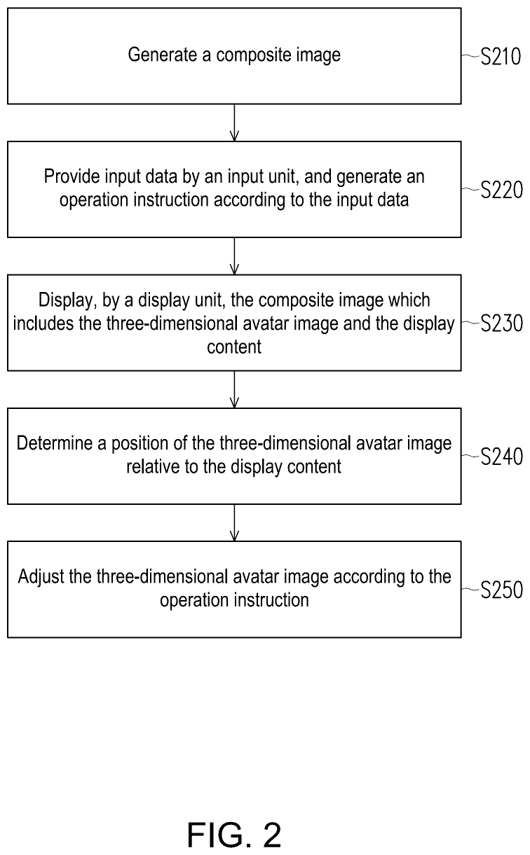

FIG. 2 is a flow chart of an image display method according to an embodiment of the disclosure. Referring to FIG. 1 and FIG. 2, the multimedia system 100 may perform the following Steps S210 to S250. In Step S210, the processing unit 110 generates a composite image. The processing unit 110 may respectively read the three-dimensional avatar image and the display content in different files, and mix/combine the three-dimensional avatar image with the display content to generate the composite image.

In Step S220, the input unit 130 provides input data, and the processing unit 110 generates an operation instruction according to the input data. In Step S230, the display unit 120 may display the composite image, in which the composite image includes the three-dimensional avatar image and the display content. In an embodiment, the display unit 120 further displays a selection interface so as to generate a selection result by an operation of a user from the selection interface. In an embodiment, the display unit 120 displays the selection interface without displaying the composite image. In an embodiment, the display unit 120 displays the composite image without displaying the selection interface. In Step S240, the processing unit 110 may determine a position of the three-dimensional avatar image relative to the display content. In other words, the processing unit 110 may determine a position of the three-dimensional avatar image relative to the display content according to the selection result of the selection interface. In other words, the processing unit 110 may determine the position of the three-dimensional avatar image relative to a position of the display content. In this embodiment, according to the selection result of the selection interface, the processing unit 110 may adjust a position of the three-dimensional avatar image being outside the display content or the position of the three-dimensional avatar image being inside the display content, or the position of the three-dimensional avatar image being within the display content in three-dimensional coordinate (for example, the three-dimensional avatar image and the display content have three-dimensional coordinate points in all three-dimensional coordinate system). In Step S250, the processing unit 110 may adjust the three-dimensional avatar image according to the operation instruction. In this embodiment, the processing unit 110 can control the actions, behaviors, or expressions of the three-dimensional avatar image in the composite image according to the operation instruction. In an embodiment, the processing unit 110 may also control the presentation of the display content according to the operation instruction, such as turning to the next page and zooming in or out.

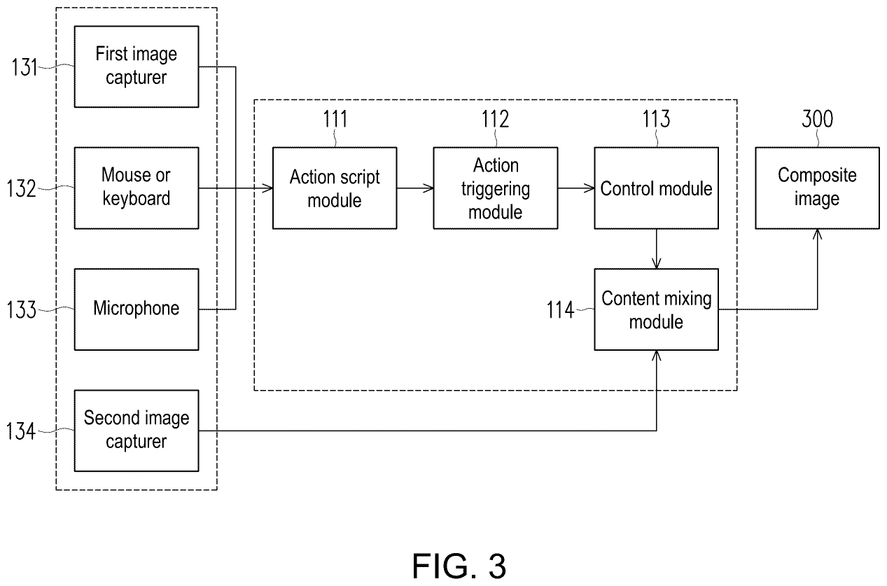

FIG. 3 is a schematic diagram of generating the composite image according to an embodiment of the disclosure. Referring to FIG. 1 and FIG. 3, specifically, the input unit 130 may include at least one of a first image capturer 131, a mouse or keyboard 132, a microphone 133, and a second image capturer 134. In this embodiment, the processing unit 110 may execute an action script module 111, an action triggering module 112, a control module 113, and a content mixing module 114 respectively, so as to generate a composite image 300. The first image capturer 131 or the second image capturer 134 may be a camera or an image sensor.

In this embodiment, the action script module 111 executed by the processing unit 110 may obtain the input data provided by the first image capturer 131, the mouse or keyboard 132, or the microphone 133, and determine whether the input data matches a preset action script to output the corresponding action script. The preset action script and the action script are stored in the storage device. In this embodiment, the processing unit 110 may, for example, read the corresponding action script through table lookup. As shown in Table 1 below, the processing unit 110 may determine the corresponding action according to the event corresponding to the input data to determine the corresponding action script, but the action and script types of the disclosure are not limited thereto.

TABLE 1

| Event | Action | Action script |
|---|---|---|
| Read (start, stop) | Read a manuscript | Read |
| Speech (start, stop) | Speech | Speech |
| Speak (start, stop) | Speak | Speak |
| Teach (start, stop) | Teach | Teach |
| Present (start, stop) | Presentation | Present |
| Circle run (start, stop) | Circle run | Circle run (object) |
| Jump (start, stop) | Jump | Jump |

In this embodiment, the action triggering module 112 may generate a related operation instruction according to the corresponding action script. In this embodiment, the control module 113 may read the three-dimensional avatar image and adjust the three-dimensional avatar image according to the operation instruction, in which the operation may include, for example, adjusting the action, behavior, or expression of the three-dimensional avatar image. In this embodiment, the content mixing module 114 may read the display content, and mix/combine the three-dimensional avatar image with the display content to generate the composite image 300. The multimedia system 100 may display the composite image 300 through the display unit 120. The composite image 300 may be a two-dimensional image or a three-dimensional image.

In an embodiment, the content mixing module 114 may also obtain a real-life image through the second image capturer 134, and the content mixing module 114 may use the real-life image as the display content, and mix the three-dimensional avatar image with the real-life image, so as to generate the composite image 300. In other words, the composite image 300 may be, for example, a mixed reality (MR) image or an augmented reality (AR) image.

In an embodiment, the display unit 120 may further display a selection interface for user operation, in which the selection interface may, for example, provide multiple selection icons or a drop-down menu for user selection. In this regard, the processing unit 110 may determine a position of the three-dimensional avatar image relative to the display content according to the selection result of the selection interface. In this embodiment, the position of the three-dimensional avatar image relative to the display content may be, for example, a position of the three-dimensional avatar image being outside the display content or the position of the three-dimensional avatar image being within the display content or the position of the three-dimensional avatar image within the display content in three-dimensional coordinate.

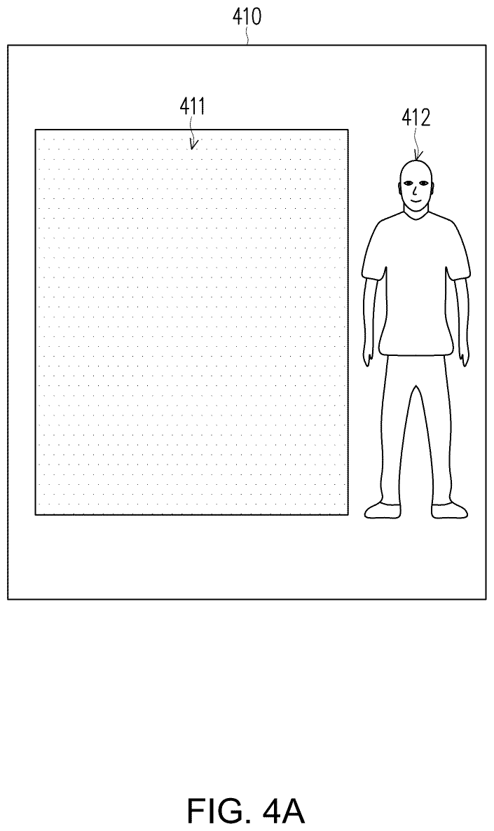

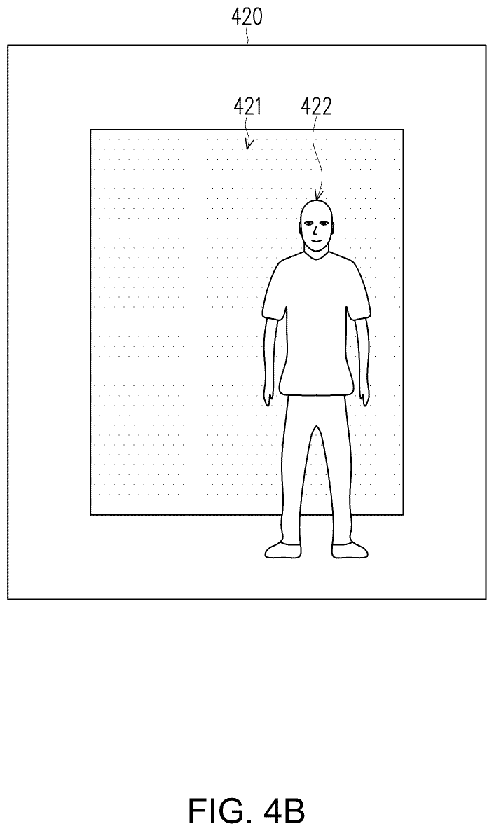

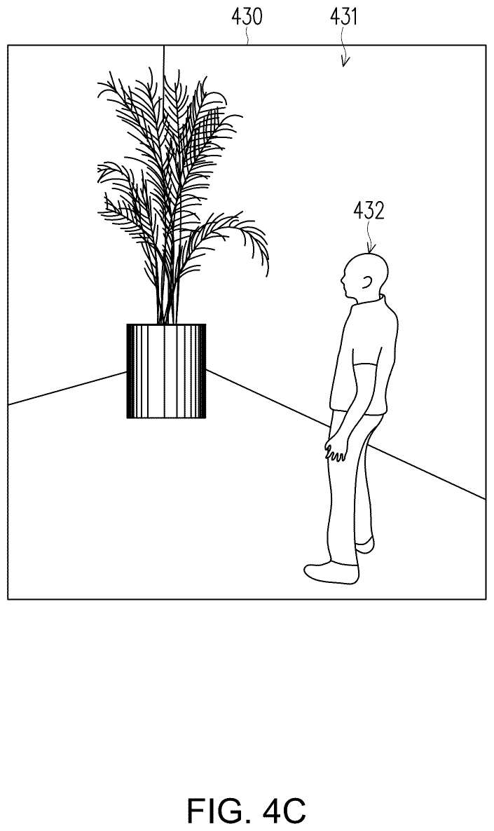

Referring to FIG. 4A together, FIG. 4A is a schematic diagram of the composite image according to an embodiment of the disclosure. As shown in FIG. 4A, the content mixing module 114 may generate a composite image 410, in which the composite image 410 includes a display content 411 and a three-dimensional avatar image 412. The content mixing module 114 may set the three-dimensional avatar image 412 outside the display content 411 to present a clear presentation effect.

Referring to FIG. 4B together, FIG. 4B is a schematic diagram of the composite image according to an embodiment of the disclosure. As shown in FIG. 4B, the content mixing module 114 may generate a composite image 420, in which the composite image 420 includes a display content 421 and a three-dimensional avatar image 422. The content mixing module 114 may set the three-dimensional avatar image 422 inside the display content 421 to present a vivid presentation effect by using the posture or action of the three-dimensional avatar image 422 as a complement. In this regard, the three-dimensional avatar image 422 may at least partially covers the display content 421.

Referring to FIG. 4C together, FIG. 4C is a schematic diagram of the composite image according to an embodiment of the disclosure. As shown in FIG. 4C, the content mixing module 114 may generate a composite image 430, in which the composite image 430 includes a display content 431 and a three-dimensional avatar image 432, and the display content 431 may be a video or a real-life image. The content mixing module 114 may set the three-dimensional avatar image 432 within the video or the real-life image, and combine the three-dimensional avatar image 432 with the video or real-life image, so as to present a vivid video, mixed reality image, or augmented reality image. To further explain, when the display content is a three-dimensional image or a three-dimensional video, the three-dimensional image or the three-dimensional video has three-dimensional coordinates, and the three-dimensional avatar image 432 also has three-dimensional coordinates. The processing unit 110 maps the three-dimensional coordinates of the three-dimensional avatar image 432 to the three-dimensional coordinates of the three-dimensional image or the three-dimensional video, so that the three-dimensional avatar image 432 is in the position of the three-dimensional coordinates of the display content. In this regard, the content mixing module 114 allows the three-dimensional avatar image 432 to perform corresponding movement effects (such as rotation, moving forward, or moving backward) in the display content (the three-dimensional image or the three-dimensional video). In this way, the composite image 430 can present a three-dimensional and interactive image.

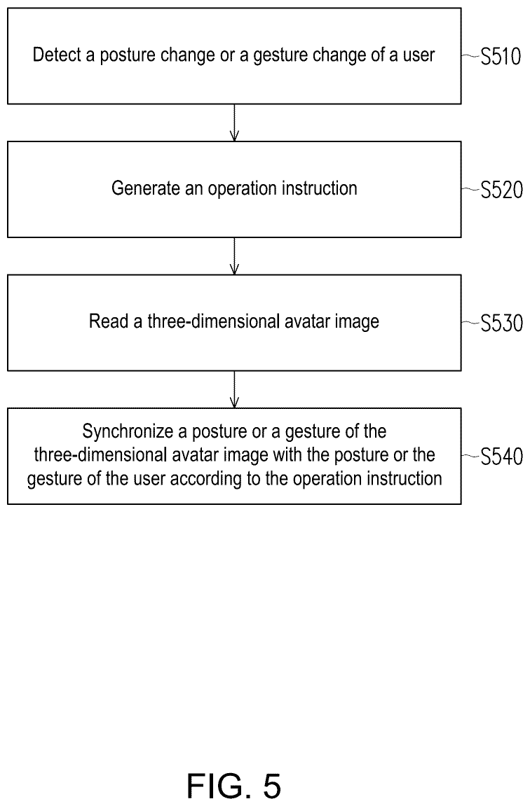

FIG. 5 is a flow chart of adjusting the three-dimensional avatar image according to an embodiment of the disclosure. Referring to FIG. 1, FIG. 3, and FIG. 5, the input unit 130 includes a first image capturer 131 as an example. The multimedia system 100 may perform the following Steps S510 to S540. In Step S510, the first image capturer 131 detects (captures) a posture change or a gesture change of a user. In Step S520, the processing unit 110 may generate an operation instruction according to the posture change or the gesture change. In this embodiment, the first image capturer 131 captures images of the face, body, and hands of the user, and generates the input data. The first image capturer 131 passes the input data to the processing unit 110. In the embodiment, the processing unit 110 executes the recognition program to identify positions of the face, body, and hand movements of the user in the input data. Then, the processing unit 110 may execute the action script module 111 and the action triggering module 112 to generate the corresponding operation instruction. In Step S530, the processing unit 110 may read the three-dimensional avatar image. In Step S540, the processing unit 110 may synchronize a posture or a gesture of the three-dimensional avatar image with the posture or the gesture of the user according to the operation instruction. In this regard, the processing unit 110 may use the content mixing module 114 to instantly perform one of the image composite methods on the adjusted three-dimensional avatar image and the display content as shown in FIG. 4A to FIG. 4C to generate the composite image 300. Moreover, the control module 113 adjusts the three-dimensional avatar image according to the operation instruction. For example, the three-dimensional avatar image may first be displayed at a preset position in the image, and then the user may move the position of the three-dimensional avatar image in the composite image through the posture change or the gesture change.

In an embodiment, the processing unit 110 may further adjust the display content according to a recognition result of the posture change or the gesture change, for example, turning pages of a document, turning pages of slides, zooming in or zooming out, or operations such as forwarding, fast forwarding, rewinding a video, or switching the perspective of the real-life image or adjusting the position of objects, for example.

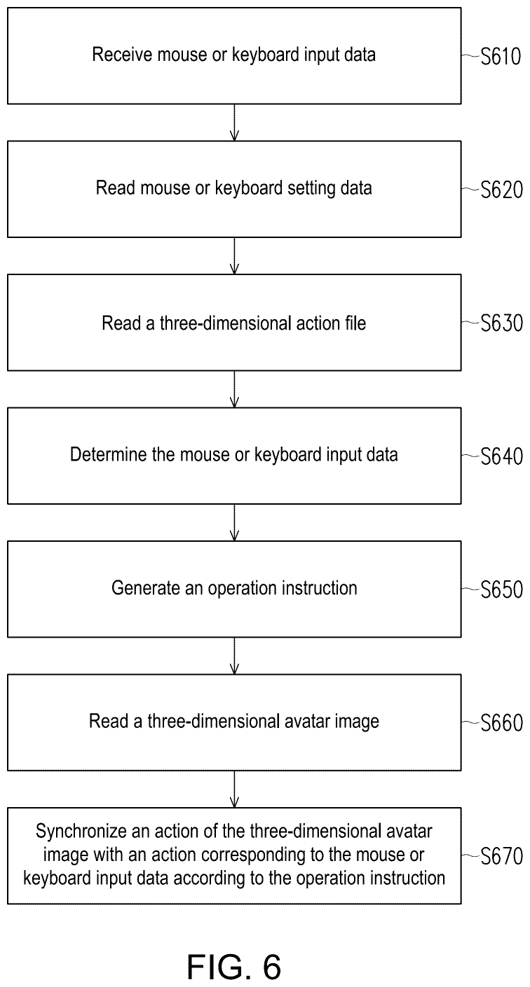

FIG. 6 is a flow chart of adjusting the three-dimensional avatar image according to an embodiment of the disclosure. Referring to FIG. 1, FIG. 3, and FIG. 6, the input unit 130 includes the mouse or a keyboard 132 as an example. The multimedia system 100 may perform the following Steps S610 to S670. In Step S610, the processing unit 110 may receive mouse or keyboard input data through a mouse or a keyboard 132. The mouse or keyboard input data is a result of the user operating the mouse or the keyboard 132. In Step S620, the processing unit 110 may read the corresponding mouse or keyboard setting data according to the mouse or the keyboard input data. In Step S630, the processing unit 110 may read a three-dimensional action file. The mouse or keyboard setting data and three-dimensional action file are stored in a storage device. The three-dimensional action file includes various actions of the three-dimensional avatar image. In Step S640, the processing unit 110 may determine the mouse or keyboard input data.

The processing unit 110 may search for the corresponding three-dimensional action file according to the mouse or keyboard setting data. In other words, the processing unit 110 may determine the action for adjusting the three-dimensional avatar image according to the operation result of the user on the mouse or keyboard 132. In Step S650, the processing unit 110 may generate a corresponding operation instruction according to the action for adjusting the three-dimensional avatar image. In Step S660, the processing unit 110 may read the three-dimensional avatar image. In Step S670, the processing unit 110 may synchronize an action of the three-dimensional avatar image with an action corresponding to the mouse or keyboard input data according to the operation instruction. In this regard, the processing unit 110 may use the content mixing module 114 to instantly perform one of the image composite methods on the adjusted three-dimensional avatar image and the display content as shown in FIG. 4A to FIG. 4C to generate the composite image 300. Moreover, the control module 113 adjusts the three-dimensional avatar image according to the operation instruction. For example, the three-dimensional avatar image may first be displayed at a preset position in the image, and then the user may move the position of the three-dimensional avatar image in the composite image through mouse or keyboard control.

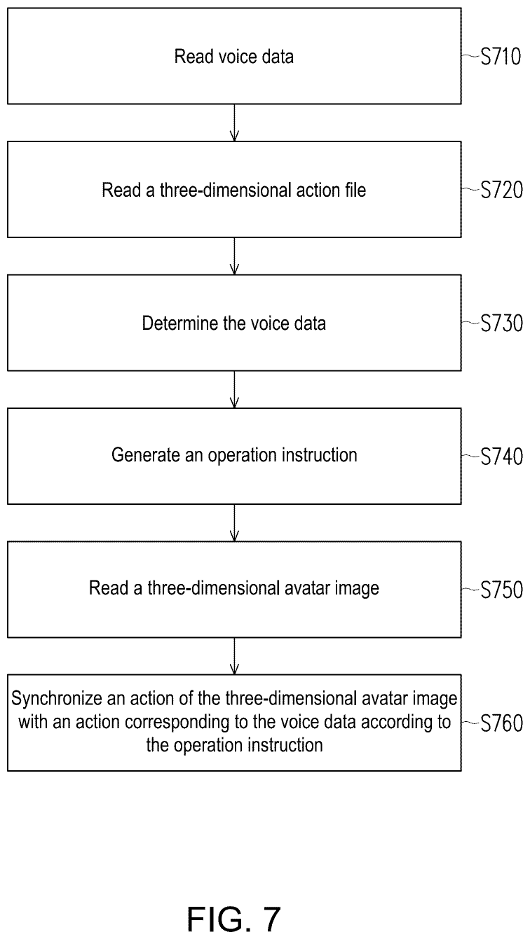

FIG. 7 is a flow chart of adjusting the three-dimensional avatar image according to an embodiment of the disclosure. Referring to FIG. 1, FIG. 3, and FIG. 7, the input unit 130 includes a microphone 133 as an example. The multimedia system 100 may perform the following Steps S710 to S760. In Step S710, the processing unit 110 may read voice data through the microphone 133. The voice data is voice control information provided by the user. In Step S720, the processing unit 110 may read the three-dimensional action file. In Step S730, the microphone 133 provides the voice data to the processing unit 110, and the processing unit 110 may determine the voice data. The processing unit 110 may search for the corresponding three-dimensional action file according to the voice data. In other words, the processing unit 110 may determine the action for adjusting the three-dimensional avatar image according to the voice control information provided by the user. In Step S740, the processing unit 110 may generate a corresponding operation instruction according to the action for adjusting the three-dimensional avatar image. In Step S750, the processing unit 110 may read the three-dimensional avatar image. In Step S760, the processing unit 110 may synchronize an action of the three-dimensional avatar image with an action corresponding to the voice data according to the operation instruction. In this regard, the processing unit 110 may use the content mixing module 114 to instantly perform one of the image composite methods on the adjusted three-dimensional avatar image and the display content as shown in FIG. 4A to FIG. 4C to generate the composite image 300. Moreover, the control module 113 adjusts the three-dimensional avatar image according to the operation instruction. For example, the three-dimensional avatar image may first be displayed at a preset position in the composite image, and then the user may move the position of the three-dimensional avatar image in the composite image through voice control.

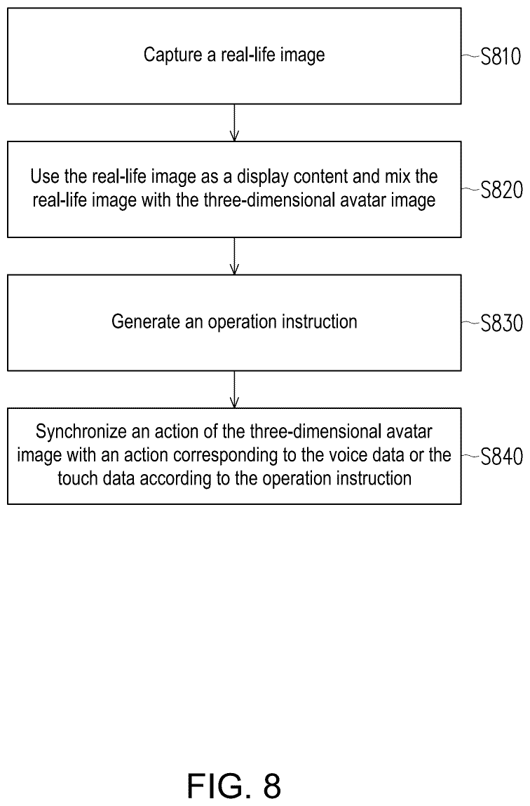

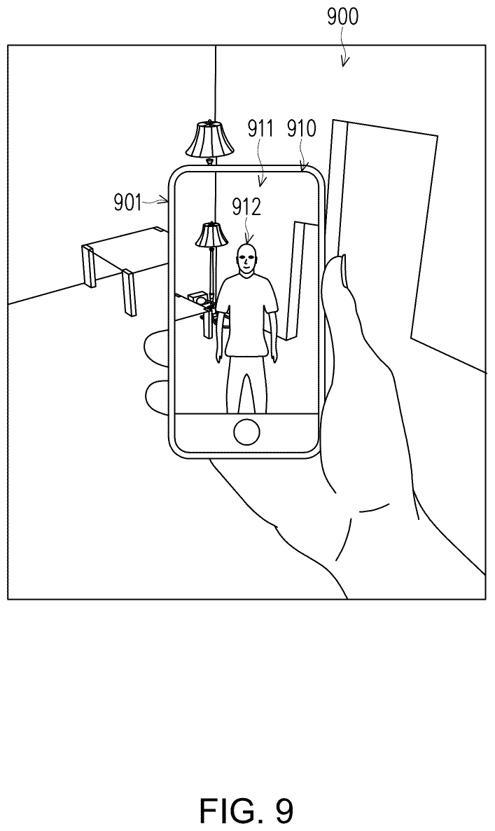

FIG. 8 is a flow chart of generating the composite image according to an embodiment of the disclosure. FIG. 9 is a schematic diagram of a mixed real-life image with the three-dimensional avatar image according to an embodiment of the disclosure. Referring to FIG. 1, FIG. 3, FIG. 8, and FIG. 9, the input unit 130 includes a second image capturer 134 as an example. The multimedia system 100 may perform the following Steps S810 to S840. In Step S810, the second image capturer 134 captures a real-life image 911 of an actual scene 900. As shown in FIG. 9, the second image capturer 134 may be, for example, a camera of a terminal device 901. In Step S820, the processing unit 110 may use the real-life image 911 as the display content. The processing unit 110 mixes the real-life image 911 with the three-dimensional avatar image 912 to generate a composite image 910. A display device of the terminal device 901 may display the composite image 910. In Step S830, the processing unit 110 may generate the operation instruction in the manner of the above embodiments. In this embodiment, voice data or touch data may be provided through an input unit such as a microphone or a touch device (such as a capacitive touch controller or a resistive touch controller installed on a display). In Step S840, the processing unit 110 may synchronize an action of the three-dimensional avatar image with an action corresponding to the voice data or the touch data according to the operation instruction. In this regard, the processing unit 110 may adjust the three-dimensional avatar image according to the operation instruction through the control module 113. Moreover, the content mixing module 114 can instantly perform one of the image composite methods on the adjusted three-dimensional avatar image and the display content as shown in FIG. 4A to FIG. 4C to generate the composite image 910 as displayed on the terminal device 901. In an embodiment, the terminal device 901 may also synchronously provide the composite image 910 to a terminal device (such as MR/AR helmets, MR/AR glasses, mobile phones, or tablets) through network communication for displaying mixed reality images or augmented reality images.

In summary, the multimedia system and the image display method of the disclosure have at least one of the following advantages. The multimedia system and the image display method of the disclosure can combine the three-dimensional avatar image with the display content to generate the composite image. The multimedia system and the image display method of the disclosure allow users to simultaneously adjust the three-dimensional avatar image or the display content through gesture control, posture control, voice control, touch control, or mouse or keyboard control, so as to present a vivid display effect with good user experience. The multimedia system and the image display method of the disclosure can also combine a three-dimensional avatar image with the real-life images to generate the composite image of mixed reality or augmented reality. The multimedia system and the image display method of the disclosure can provide the composite images to different terminal devices for synchronous display.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A multimedia system, comprising:
an input unit configured to provide input data;
a processing unit communicatively connected to the input unit, wherein the processing unit is configured to generate an operation instruction according to the input data and configured to generate a composite image; and
a display unit communicatively connected to the processing unit and configured to display the composite image, wherein the composite image comprises a three-dimensional avatar image and a display content, wherein
the processing unit is configured to determine a position of the three-dimensional avatar image relative to the display content, and the processing unit is configured to adjust the three-dimensional avatar image according to the operation instruction.

2. The multimedia system as claimed in claim 1, wherein the display unit is configured to display a selection interface so as to generate a selection result from the selection interface, the processing unit is configured to, according to the selection result, adjust the position of the three-dimensional avatar image being outside the display content or the position of the three-dimensional avatar image being within the display content or the position of the three-dimensional avatar image within the display content in three-dimensional coordinate.

3. The multimedia system as claimed in claim 1, wherein the processing unit is configured to read a corresponding action script according to the input data provided by the input unit, and generate the operation instruction according to the corresponding action script.

4. The multimedia system as claimed in claim 1, wherein the input unit comprises an image capturer, wherein
the processing unit is configured to capture a real-life image through the image capturer, and the display content comprises the real-life image.

5. The multimedia system as claimed in claim 1, wherein the input unit comprises an image capturer, wherein
the processing unit is configured to detect a posture change of a user through the image capturer, and generate the operation instruction according to the posture change.

6. The multimedia system as claimed in claim 1, wherein the input unit comprises an image capturer, wherein
the processing unit is configured to detect a gesture change of a user through the image capturer, and generate the operation instruction according to the gesture change.

7. The multimedia system as claimed in claim 1, wherein the input unit comprises a mouse or a keyboard, wherein
the processing unit is configured to generate the operation instruction according to an operation result of the mouse or the keyboard.

8. The multimedia system as claimed in claim 1, wherein the input unit comprises a microphone, wherein
the processing unit is configured to obtain a sound signal according to the microphone, and generate the operation instruction according to the sound signal.

9. The multimedia system as claimed in claim 1, wherein the processing unit further communicatively connects to a terminal device, the processing unit is configured to output the composite image to the terminal device, and a display device of the terminal device is configured to display the composite image.

10. An image display method, comprising:
generating, by a processing unit, a composite image;
providing, by an input unit, input data;
generating, by the processing unit, an operation instruction according to the input data;
displaying, by a display unit, the composite image, wherein the composite image comprises a three-dimensional avatar image and a display content;
determining, by the processing unit, a position of the three-dimensional avatar image relative to the display content; and
adjusting, by the processing unit, the three-dimensional avatar image according to the operation instruction.

11. The image display method as claimed in claim 10, further comprising:
displaying, by the display unit, a selection interface so as to generate a selection result; and
adjusting, according to the selection result, the position of the three-dimensional avatar image being outside the display content or the position of the three-dimensional avatar image being within the display content or the position of the three-dimensional avatar image within the display content in three-dimensional coordinate by the processing unit.

12. The image display method as claimed in claim 10, further comprising:
reading a corresponding action script according to the input data provided by the input unit; and
generating the operation instruction according to the corresponding action script.

13. The image display method as claimed in claim 10, further comprising:
capturing a real-life image through an image capturer, and wherein the display content comprises the real-life image.

14. The image display method as claimed in claim 10, wherein a step of generating the operation instruction comprises:
detecting a posture change of a user through an image capturer, and generating the operation instruction according to the posture change.

15. The image display method as claimed in claim 10, wherein a step of generating the operation instruction comprises:
detecting a gesture change of a user through an image capturer, and generating the operation instruction according to the gesture change.

16. The image display method as claimed in claim 10, wherein a step of generating the operation instruction comprises:
generating the operation instruction according to an operation result of a mouse or a keyboard.

17. The image display method as claimed in claim 10, wherein a step of generating the operation instruction comprises:
obtaining a sound signal from a microphone, and generating the operation instruction according to the sound signal.

18. The image display method as claimed in claim 10, further comprising:
outputting the composite image to a terminal device, so that the terminal device displays the composite image.
